(19) United States
(12) Patent Application Publication
(10) Pub. No.: US 2003/0012988 A1
(43) Pub. Date: Jan. 16, 2003

(54) Proton conducting polymer membrane for electrochemical cell

(76) Inventors: John Malcom Gascoyne, Bucks (GB); Thomas Robinson Ralph, Reading (GB); Graham Alan Hards, Reading (GB)

Correspondence Address: Paul F Prestia, Ratner Prestia, One Westlakes Berwyn Suite 301, PO Box 980, Valley Forge, PA, 19482-0980, US

(21) Appl. No.: 10/204,382

(22) PCT Filed: Mar. 16, 2001
(86) PCT No.: PCT/GB01/01181

(30) Foreign Application Priority Data
Mar. 17, 2000 (GB) 0006428/7

(51) Int. Cl. H01M 8/10; C08J 5/22

(52) U.S. Cl. 429/13; 521/27; 429/33

(57) ABSTRACT

A novel proton conducting polymer membrane which contains a network of voids within the membrane is disclosed. Such a membrane allows for a reservoir of additional water within a fuel cell comprising said membrane, such that water electrolysis is sustained in the cell during incidences of cell reversal. Methods for the construction of such a membrane are also provided.

The present invention relates to a novel proton conducting polymer membrane which contains a network of voids within the membrane. A membrane of the present invention when assembled into a membrane electrode assembly (MEA) allows for a reservoir of additional water within the MEA to sustain water electrolysis during incidences of cell reversal.

A fuel cell is an energy conversion device that efficiently converts chemical energy into electrical energy by electrochemically combining either hydrogen, stored as a gas, or methanol stored as a liquid or gas, with oxygen, normally in the form of air, to generate electrical power. At their fundamental level fuel cells comprise electrochemical cells formed from a solid or liquid electrolyte and two electrodes, the anode side and cathode side, at which the desired electrochemical reactions take place. In the fuel cell the hydrogen or methanol is oxidised at the anode side and the oxygen is reduced at the cathode side to generate the electrical power. Normally in fuel cells the reactants are in gaseous form and have to be diffused into the anode and cathode structures. The electrode structures are therefore specifically designed to be porous to gas diffusion in order to optimise the contact between the reactants and the reaction sites in the electrode to maximise the reaction rate. Efficient removal of the reaction products from the electrode structures is also important. In cases where liquid reactants and products are present the electrode structures often have to be tailored to efficiently feed reactants to and remove products from the reaction sites. The electrolyte also has to be in contact with both electrodes and in fuel cell devices may be acidic or alkaline, liquid or solid in nature. The proton exchange membrane fuel cell (PEMFC), however, is the most likely type of fuel cell to find wide application as an efficient and low emission power generation technology for a range of markets. It is likely to find early application in a range of stationary, residential and portable power generation devices and as an alternative to the internal combustion engine for transportation. In the PEMFC, whether hydrogen or methanol fuelled, the electrolyte is a solid proton-conducting polymer membrane, commonly based on perfluorosulphonic acid materials.

In the PEMFC the combined laminate structure formed from the membrane and the two electrode structures is known as a membrane electrode assembly (MEA). The MEA typically comprises several layers, but in general can be considered to comprise five layers, the nature of which is dictated by their function. On either side of the membrane an anode and cathode electrocatalyst is incorporated to increase the rates of the desired electrode reactions. In contact with the electrocatalyst containing layers, on the opposite face to that in contact with the membrane, are the anode and cathode gas diffusion substrate layers. The anode gas diffusion substrate is designed to be porous. This allows the reactant hydrogen or methanol to enter from the face of the substrate exposed to the reactant fuel supply. The reactant then diffuses through the thickness of the substrate to the layer containing the electrocatalyst, which is usually platinum metal based, to maximise the electrochemical oxidation of hydrogen or methanol. The anode electrocatalyst layer is also designed to comprise some level of proton conducting electrolyte in contact with the same electrocatalyst reaction sites. With acidic electrolyte types the product of the anode reaction is protons and these can then be efficiently transported from the anode reaction sites through the electrolyte to the cathode layers. The cathode substrate is also designed to be porous and to allow oxygen or air to enter the substrate and diffuse through to the electrocatalyst layer reaction sites. The cathode electrocatalyst combines the protons with oxygen to produce water and is also designed to comprise some level of the proton conducting electrolyte in contact with the same electrocatalyst reaction sites. Product water then has to diffuse out of the cathode structure. The structure of the cathode has to be designed such that it enables the efficient removal of the product water. If water builds up in the cathode it becomes more difficult for the reactant oxygen to diffuse to the reactant sites, and thus the performance of the fuel cell decreases. In the case of methanol fuelled PEMFCs, additional water is present due to the water contained in the methanol, which can be transported through the membrane from the anode to the cathode side. The increased quantity of water at the cathode requires removal. However it is also the case with proton conducting membrane electrolytes, that if too much water is removed from the cathode structure, the membrane can dry out resulting in a significant decrease in the performance of the fuel cell.

The complete MEA can be constructed by several methods. The electrocatalyst layers can be bonded to one surface of the gas diffusion substrate to form what is known as a catalysed gas diffusion substrate. Two catalysed gas diffusion substrates can be combined with the solid proton-conducting membrane to form the MEA. Alternatively, the solid proton-conducting polymer membrane is first catalysed on both sides to form a catalyst coated membrane (CCM) and then combined with two porous gas diffusion substrates to produce the MEA. Further, one catalysed gas diffusion substrate can be combined with one gas diffusion substrate and a solid proton-conducting polymer membrane that is catalysed on the side facing the gas diffusion substrate to form the MEA.

The materials typically used in the fabrication of the gas diffusion substrate layers of an MEA comprise high density materials such as rigid carbon fibre paper (e.g. Toray TGP-H-60 or TGP-H-90 from Toray Industries, Japan) or woven carbon cloths, such as Zoltek PWB-3 (Zoltek Corporation, 3101 McKelvey Road, St. Louis, Mo. 63044, USA). Substrates such as these are usually modified with a particulate material either embedded within the fibre network or coated on to the large planar surfaces, or a combination of both. Typically these particulate materials comprise a carbon black and polymer mix. The particulate carbon black material is, for example, an oil furnace black such as Vulcan XC72R (from Cabot Chemicals, Billerica, Mass., USA) or an acetylene black such as Shawinigan (from Chevron Chemicals, Houston, Tex., USA). The polymer most frequently used is polytetrafluoroethylene (PTFE). The coating, or embedding, is carried out in order to improve the water management properties, improve gas diffusion characteristics, to provide a continuous surface on which to apply the catalyst layer and to improve the electrical conductivity. More recently, electrode structures based on gas diffusion substrates comprising a non-woven network of carbon fibres (carbon fibre structures such as Optimat 203, from Technical Fibre Products, Kendal, Cumbria, UK) with a particulate material embedded within the fibre network as disclosed in EP 0 791 974 have shown comparable performances to structures based on carbon fibre paper or cloth.

The electrocatalyst materials for the anode and cathode structures typically comprise precious metals, in particular platinum, as these have been found to be the most efficient and stable electrocatalysts for all low-temperature fuel cells such as the PEMFC. Platinum is employed either on its own as the only electrocatalytic metal or in combination with other precious metals or base metals. The platinum based electrocatalyst is provided as very small particles (˜20-50 Å) of high surface area, which are usually distributed on and supported by larger macroscopic conducting carbon particles to provide a desired catalyst loading. Conducting carbons are the preferred materials to support the catalyst. Particulate carbon black materials typically employed include Vulcan XC72R and Shawinigan. It is also possible that the platinum-based electrocatalyst may not incorporate a support, and in this case it is referred to as an unsupported Pt electrocatalyst.

Each MEA in the PEMFC is sandwiched between electrically conducting flow field plates that are conventionally based on carbon and contain channels that feed the MEA with the reactants and through which the products are removed. Since each MEA typically delivers 0.6−0.7 V, usually between 10 to 100 such MEAs are located between flow field plates to form stacks. These stacks are combined electrically in series or parallel to give the desired power output for a given application.

Recently it has been reported that during prolonged operation some cells in large stacks can go into an undesired condition known as cell reversal. This is shown by the cell potential becoming negative rather than the positive value associated with normal PEMFC operation. Such cell reversals can be due to depletion in the concentration of the reactants at the cathode or anode sides, which can be caused by a number of factors such as restricted gas flow due to blocked flow fields or poor water distribution in the MEA. Allied to this in situations where a fast dynamic response is required, such as in transportation applications, it is possible that the gas flow cannot respond quickly enough to sustain the current demand. Further, if one cell in a stack shows cell reversal it can result in adjacent cells in the stack also showing cell reversal since they are in electrical contact.

If the cell reversal is due to a restricted oxygen concentration at the electrocatalyst sites in the cathode then, to sustain the flow of current, hydrogen is produced at the cathode,

2 H⁺+2e⁻=H₂

Since hydrogen production at the cathode is very facile at the platinum-based electrocatalysts typically employed the electrode potential is usually only slightly more negative than that for hydrogen oxidation at the anode. The result is that at normal operating current densities the cell voltage is normally slightly negative e.g. −0.1 V. This type of cell reversal does raise safety and durability concerns since hydrogen is being produced in the oxidant side of the cell, a significant quantity of heat is generated and water is no longer being produced at the cathode. This water helps to sustain membrane hydration especially at the membrane-anode interface since it promotes the back-diffusion of water.

The major problem occurs, however, if the hydrogen concentration is restricted at the anode side. In this case to sustain the flow of current water electrolysis and carbon corrosion can occur,

2H₂O=O₂+4H⁺+4e⁻

C+2H₂O=CO₂+4H⁺+4e⁻

Since both electrode reactions occur at more positive electrode potentials than oxygen reduction at the cathode, again, the cell voltage is negative, but in this case the cell voltage may be as high as −0.8 V at typical operating current densities. While carbon corrosion is favoured over water electrolysis thermodynamically, the electrochemical kinetics of water electrolysis are sufficiently facile at the platinum based electrocatalysts typically employed in the PEMFC that initially water electrolysis principally sustains the current. There is only a small contribution from corrosion of the carbon components in the anode to the cell current. If, however, the anode catalyst becomes deactivated for water electrolysis, or if the water concentration at the electrocatalyst sites in the anode becomes significantly depleted, the water electrolysis current is gradually replaced by increased rates of carbon corrosion. In the case of carbon corrosion water need only be present in the vicinity of the relevant, abundant carbon surfaces. During this period the cell voltage becomes more negative (i.e. the anode potential becomes more positive) to provide the necessary driving force for carbon corrosion. This in turn increases the driving force for the water electrolysis reaction. The result if cell reversal is prolonged may be irreversible damage to the membrane and catalyst layers due to excessive dehydration and local heating. Further, the catalyst carbon support in the anode structure corrodes, with eventual dissolution of the platinum based catalyst from the support and the anode gas diffusion substrate may become degraded due to corrosion of the carbon present in the substrate structure. In cases where the bipolar flow field plates are based on carbon the anode flow field plate may also be subjected to significant carbon corrosion, resulting in surface pitting and damage to the flow field pattern.

Therefore it would be a significant advantage if the MEA could be protected from the deleterious effects of cell reversal should a cell go into a reversal situation. This is the problem the present inventors have set out to address.

The major causes of irreversible cell damage that can occur under cell reversal conditions at the anode can be ameliorated if water electrolysis can be sustained by maintaining a sufficiently high water concentration within the MEA. This significantly reduces the potential for onset of corrosion of the carbon-based materials in the anode side of the MEA. The ability to sustain water electrolysis at the anode even for a short time can be critical in giving time for detecting the cell reversal and rectifying the problem. In order to achieve such a water buffer requires that a supply of water is retained within the MEA structure to compensate for the disruption to the existing water flux whilst supplying additional water to the anode for the electrolysis reaction.

One approach to achieving this objective is by the creation of a void structure within the membrane that is able to retain additional water (that is water, in addition to that required for complete membrane wetting) whilst not compromising the specific proton conductivity of the membrane.

To achieve such a water reservoir requires a suitable structure wherein water can be collected and stored from either the gas streams supplying the reactant gases or the product water created by the normal functioning of the fuel cell. The only requirement is some form of void structure within the membrane that does not significantly compromise the specific proton conductivity of the membrane during normal operation.

Previous approaches to increasing the hydration of solid polymer electrolyte membranes in fuel cells have involved such methods as incorporating wicks into the membrane structure (Watanabe et al, J. Electrochem. Soc., vol. 140, No. 11, 1993). Unfortunately a number of problems with this type of approach have been encountered. Typically, modern PEM fuel cells require solid polymer electrolyte membranes less than 150 microns thick and preferably less than 60 microns thick, whereas the membranes described in the literature have been much thicker (of the order of at least 200 microns). The polyester wicks employed by Watanabe et al being typically of between 60 and 80 microns in diameter would significantly effect the proton conductivity and physical integrity of a membrane of 100 microns or less in thickness. In addition these systems rely on supplying water from a source external to the cell itself.

Passages have also been created in proton conducting membranes for use in electrochemical cells in order to allow direct fluid flow through the membrane for the purposes of hydration. Thus Cisar et al in U.S. Pat. No. 5,635,039 describe the formation of open, substantially unobstructed, parallel internal passages within a proton conducting membrane. The passages are formed by pressing a membrane or two membranes around a plurality of removable elements at sufficient temperature and pressure to fuse the material. The elements are subsequently removed to form the substantially unobstructed, parallel internal passages. In this application, as for previous attempts to introduce water directly into the membrane, large channels typically of the order of 51 to 230 microns in diameter were formed in the proton exchange membranes. These channels are clearly too large to be incorporated into the thin membranes used in modern PEMFC technology. A subsequent patent U.S. Pat. No. 5,916,505 by Cisar et al describes the process for forming the membrane and also describes the inclusion of preformed proton conducting polymer tubes into a cast membranes, but again the channels are large relative to the membrane thickness. Again these systems require an external source of water for them to function in the appropriate manner. The channels allow fluid flow through the membrane, and as such are not designed to achieve fluid retention within the passages.

The formation of a network of voids which may act as water reservoirs within a proton conducting polymer membrane of a fuel cell in order to sustain the process of water electrolysis under cell reversal conditions has never before been described.

Thus in a first aspect, the present invention provides a proton conducting membrane characterised in that said membrane contains a network of voids within the thickness of the membrane.

In a second aspect, the present invention provides the use of a membrane according to the present invention in a fuel cell wherein additional water is retained in the voids.

The term void is used to describe a space within the polymer membrane where there is no polymer. When the membrane is incorporated into a MEA and into a fuel cell, these voids are able to retain water.

The shape of the individual voids can vary and will depend on the method by which the voids are created. In the case where the voids are formed from particles, the shape may be spherical, oblate spheroidal or irregular; when the voids are made from fibres, the cross-sectional shape may also vary and may be circular, ellipsoidal or irregular.

The voids act as reservoirs for the storage of additional water generated during the normal operation of the fuel cell. The term ‘additional water’ in the context of the present invention means water in addition to that required for complete membrane wetting. A proton conducting polymer membrane of the present invention has the ability to sustain water hydrolysis under cell reversal conditions for a period of time sufficient for detection and rectification of the problem. In doing so it prevents the shift to carbon corrosion and consequent irreversible damage to the carbon containing components of the fuel cell.

Typically the overall thickness of the membrane is less than 100 microns and more preferably it is of thickness less than 60 microns. A membrane of 100 microns or less is suitable for use as a membrane in a high performance fuel cell.

The voids are preferably small in comparison to the thickness of the membrane. Suitably, in the z-direction of the membrane, the voids are smaller than 20 microns, preferably smaller than 10 microns. In the x and y-directions, the voids may be larger than this. The voids can be very small, but at least one dimension in any direction (x, y or z) should be greater than 10 nm. By the x- and y-directions we mean a direction parallel to the major planar faces of the membrane; by the term z-direction, we mean through the thickness of the membrane and perpendicular to its major planar faces.

The distribution of the voids throughout the membrane is suitably random, but the amount of the voids per unit volume may not be uniform across the membrane. A majority of the voids may be adjacent to one face of the membrane. Alternatively, the majority of the voids may be found in the centre of the membrane. Preferably the majority of the voids are completely within the membrane and are not at the edges of the membrane.

The inclusion of voids in the membrane may affect the proton conductivity and mechanical strength of the membrane. Suitably the number of voids is such that high proton conductivity and good mechanical strength are retained.

In a third aspect the present invention provides a method for the generation of a membrane according to the present invention comprising the step of placing fibres within the membrane during its fabrication and subsequently substantially removing them to create a network of voids.

In a further aspect the present invention provides a method for the generation of a membrane according to the present invention comprising the step of placing particles within the membrane during its fabrication and subsequently substantially removing them to create a network of voids.

In a yet further aspect, the present invention provides a method for the generation of a membrane according to the present invention comprising the step of placing fibres and particles within the membrane during its fabrication and subsequently substantially removing them to create a network of voids.

Such materials are typically of a chemical composition such that they can be substantially removed either by dissolution or by chemical decomposition to create the network of voids. Additionally they will be of a controlled particle size distribution or defined diameter and length. The fibres and/or particles may be added to a solution of the proton conducting membrane electrolyte, or to the thermoplastic precursor thereof. Alternatively, a continuous manufacturing process such as paper-making can be adapted, to form a continuous fibrous web for subsequent filling with the membrane electrolyte, as disclosed in EPA 0875524, but in which the fibrous web contains a certain portion of the soluble or chemically decomposable fibres and/or particles. The membrane may comprise particles or fibres or a mixture of particles and fibres.

Suitable fibres include but are not limited to any one or more of the following materials: polyvinyl alcohol (PVA), polyimide, cellulose acetate, polyethylene oxide, cellulose nitrate, poly-saccharides or polyethylene glycols. The fibres may be selected from a group containing longer fibres, shorter fibres, or a combination of longer and shorter fibres. The longer fibres having an average length greater than 3 mm and suitably not greater than 50 mm. The diameter of the longer fibres is typically in the range of 0.2 microns to 20 microns. The shorter fibres have an average length less than 3 mm. The diameter of the shorter fibres is typically in the range 0.1 microns to 20 microns.

Suitable particles may be of similar composition to the fibres or may include other suitable material such as sodium chloride, ammonium chloride, potassium chloride, calcium carbonate or sucrose.

The effect of the removal of the fibres and/or particles is that a network of individual voids is created within the membrane which fill with water during fuel cell operation. The internal voids will increase the time the anode can sustain a cell reversal by acting as a water reservoir. The dimension and orientation of the internal voids will depend on the size of the fibres employed and on their location through the depth of the membrane.

The resultant membrane with internal voids can then be catalysed with the platinum-based electrocatalysts normally employed in fuel cell reactions to form a catalyst coated membrane and placed adjacent typical gas diffusion substrates employed in the PEMFC to form the MEA or alternatively combined with catalysed cathode and anode substrates to form the MEA.

Although it is preferable to remove substantially all the fibres and/or particles from the membrane prior to fabrication of the MEA, it may also be possible to remove the fibre or particle materials after the fabrication of the MEA, either before or after incorporation into the fuel cell.

In a further aspect, the present invention provides a membrane electrode assembly (MEA) comprising a membrane according to the present invention.

Such a membrane containing internal voids when incorporated in an MEA may not only produce the benefit of improved tolerance to cell reversal, but will also offer improved performance at low reactant gas pressures close to ambient pressure, where gas flow rates are higher at a given reactant stoichiometry, and at lower levels of reactant gas humidification. Both low pressure and low humidification are advantageous from a fuel cell stack system efficiency viewpoint. This will be achieved as a result of the ability to balance the humidity of the membrane externally and as a result of the higher water content of the membrane improving the tolerance to membrane drying, which results in a significant loss in fuel cell performance due to the increased ohmic drop across the membrane electrolyte.

In a further aspect, the present invention provides a fuel cell comprising a membrane or an MEA according to the present invention.

In a final aspect, the present invention provides a method of operating a fuel cell under cell reversal conditions, comprising the use of a membrane according to the present invention to provide a reservoir of water within the membrane electrode assembly.

The proton conducting polymers suitable for use in the present invention may include, but are not limited to:

1) Polymers which have structures with a substantially fluorinated carbon chain optionally having attached to it side chains that are substantially fluorinated. These polymers contain sulphonic acid groups or derivatives of sulphonic acid groups, carboxylic acid groups or derivatives of carboxylic acid groups, phosphonic acid groups or derivatives of phosphonic acid groups, phosphoric acid groups or derivatives of phosphoric acid groups and/or mixtures of these groups. Perfluorinated polymers include Nafion®, Flemion® and Aciplex® commercially available from E. I. DuPont de Nemours (U.S. Pat. Nos. 3,282,875; 4,329,435; 4,330,654; 4,358,545; 4,417,969; 4,610,762; 4,433,082 and 5,094,995), Asahi Glass K K and Asahi Chemical Industry respectively. Other polymers include those covered in U.S. Pat. No. 5,595,676 (Imperial Chemical Industries plc) and U.S. Pat. No. 4,940,525 (Dow Chemical Co.)

2) Perfluorinated or partially fluorinated polymers containing aromatic rings such as those described in WO 95/08581, WO 95/08581 and WO 97/25369 (Ballard Power Systems) which have been functionalised with SO₃H, PO₂H₂, PO₃H₂, CH₂PO₃H₂, COOH, OSO₃H, OPO₂H₂, OPO₃H₂. Also included are radiation or chemically grafted perfluorinated polymers, in which a perfluorinated carbon chain, for example, PTFE, fluorinated ethylene-propylene (FEP), tetrafluoroethylene-ethylene (ETFE) copolymers, tetrafluoroethylene-perfluoroalkoxy (PFA) copolymers, poly (vinyl fluoride) (PVF) and poly (vinylidene fluoride) (PVDF) is activated by radiation or chemical initiation in the presence of a monomer, such as styrene, which can be functionalised to contain an ion exchange group.

3) Fluorinated polymers such as those disclosed in EP 0 331 321 and EP 0345 964 (Imperial Chemical Industries plc) containing a polymeric chain with pendant saturated cyclic groups and at least one ion exchange group which is linked to the polymeric chain through the cyclic group.

4) Aromatic polymers such as those disclosed in EP 0 574 791 and U.S. Pat. No. 5,438,082 (Hoechst A G) for example sulphonated polyaryletherketone. Also aromatic polymers such as polyether sulphones which can be chemically grafted with a polymer with ion exchange functionality such as those disclosed in WO 94/16002 (Allied Signal Inc.).

5) Nonfluorinated polymers include those disclosed in U.S. Pat. No. 5,468,574 (Dais Corporation) for example hydrocarbons such as styrene-(ethylene-butylene)-styrene, styrene-(ethylene-propylene)-styrene and acrylonitrile-butadiene-styrene co-and terpolymers where the styrene components are functionalised with sulphonate, phosphoric and/or phosphonic groups.

6) Nitrogen containing polymers including those disclosed in U.S. Pat. No. 5,599,639 (Hoechst Celanese Corporation), for example, polybenzimidazole alkyl sulphonic acid and polybenzimidazole alkyl or aryl phosphonate.

7) Any of the above polymers which have the ion exchange group replaced with a sulphonyl chloride (SO₂Cl) or sulphonyl fluoride (SO₂F) group rendering the polymers melt processable. The sulphonyl fluoride polymers may form part of the precursors to the ion exchange membrane or may be arrived at by subsequent modification of the ion exchange membrane. The sulphonyl halide moieties can be converted to a sulphonic acid using conventional techniques such as, for example, hydrolysis.

The membranes themselves may be of a composite type as for example described in EP 0 875 524 (Johnson Matthey PLC), U.S. Pat. No. 5,834,523 (Ballard Power Systems Inc.) and U.S. Pat. No. 5,547,551 (W. L Gore & Associates Inc.). Alternatively a layered or laminate membrane may be used, in which at least one of the layers is a membrane of the invention.

It will be appreciated that variations can be made to the invention herein described without departing from the present inventive concept.

The following examples are illustrative but not limiting of the invention:

### COMPARATIVE EXAMPLE 1

A 30% solution of perfluorosulphonic acid (Nafion® produced by E. I. DuPont de Nemours) was obtained by extracting dissolved Nafion® in an alcohol/water solution (supplied by Solution Technologies Inc., Mendenhall, Pa., USA.) into dimethylacetamide. The 30% solution was applied to the surface of a sheet of plate glass, with a raised border, to form a continuous layer. The plate glass sheet was then placed in a vacuum oven at 110° C. under a low vacuum for a period of 6 hours. Upon removal a sheet of Nafion membrane, of average thickness of 50 microns, was obtained.

### COMPARATIVE EXAMPLE 2

A mixture of chopped silica fibres (Type QC9/33-20 mm from Quartz et Silice BP 521-77794 Nemours, Cedex, France) 0.37 g, and silica microfibre (Q fibre, type 104 from Johns Manville, Insulation Group, PO Box 5108, Denver, Colo., USA) 0.18 g were dispersed with mixing, in water (3000 cm³). A porous fibre sheet was fabricated from the resulting mixture in a single step process based on the principles of paper-making technology, as a sheet size of 855 cm² (33 cm diameter) in a sheet former (design based on standard SCA Sheet former from AB Lorentzen & Wettre, Box 4, S-16393 Stockholm, Sweden). The porous fibre sheet was removed from the wire and air dried at 150° C.

The porous fibre sheet was placed on a sheet of plate glass, with a raised border and a solution of perfluorosulphonic acid, at 30 wt % solids, in dimethylacetamide (as for Comparative example 1) was applied to the surface, to form a continuous layer. The plate glass sheet was then placed in a vacuum oven at 110° C. under a low vacuum for a period of 6 hours. Upon removal a sheet of Nafion membrane, of average thickness of 60 microns, was obtained.

### EXAMPLE 1

15 wt % of potassium chloride powder (sieved to <10 microns) was dispersed into a 30 wt % solution of perfluorosulphonic acid in dimethylacetamide (prepared as for Comparative Example 1). The 30% solution was applied to the surface of a sheet of plate glass, with a raised border, to form a continuous layer. The plate glass sheet was then placed in a vacuum oven at 90° C. under a low vacuum for a period of 4 hours. Upon removal a sheet of Nafion membrane, containing particulate potassium chloride, of average thickness of 50 microns, was obtained. The potassium chloride was extracted from the membrane by repeated boiling in 0.1 molar sulphuric acid until no chloride could be detected in the solution.

### EXAMPLE 2

A mixture of chopped silica fibres (Type QC9/33-20 mm) 0.37 g, silica microfibre (Q fibre, type 104) 0.18 g and 0.05 g of polyvinyl alcohol fibres (type Mewlon SML supplied by Unitika Ltd., Osaka 541, Japan) were dispersed with mixing, in water (3000 cm³). A porous fibre sheet was fabricated from the resulting mixture in a single step process as for Comparative Example 2. The porous fibre sheet was removed from the wire and air dried at 90° C.

The porous fibre sheet containing the PVA fibres, was placed on a sheet of plate glass, with a raised border and a solution of perfluorosulphonic acid, at 30 wt % solids, in dimethylacetamide (as for Comparative example 1) was applied to the surface, to form a continuous layer. The plate glass sheet was then placed in a vacuum oven at 90° C. under a low vacuum for a period of 10 hours. Upon removal a sheet of Nafion membrane, of average thickness of 60 microns, was obtained.

The polyvinyl alcohol fibres were extracted from the membrane by repeated boiling in deionised water, followed by 0.1 molar sulphuric acid.

Comparison of Membranes

Nafion® membrane type 112 (produced by E. I. DuPont de Nemours, Polymer Products Department,Fayetteville, N.C. USA) was used as received.

10×10 cm squares were cut from each of the membrane sheets. A measurement of each membrane's mass was taken before the sample was placed in a sealable polyethylene bag of known weight. With the bag seal open, the membrane was dried overnight (˜16 h) at 40° C. under vacuum (˜10 mbar). After releasing the vacuum, the bag was quickly sealed before being weighed. Mass loss from the membrane and bag together was adjusted for the average mass loss from three identical bags containing no membrane.

The membrane was placed in 2 liters of deionised water, and heated to boiling and maintained at boiling for 90 minutes. After cooling the membrane was removed from the deionised water and the excess surface water removed by blotting with filter paper, prior to weighing.

Four samples of each membrane were treated and the averaged results of the water uptake were calculated:

| | Average Thickness | Water Uptake |
|---|---|---|
| Sample | μm | Wt % |
| Comparative Example 1 | 50 | 39.4 |
| Comparative Example 2 | 60 | 41.0 |
| Example 1 | 50 | 71.7 |
| Example 2 | 60 | 88.2 |
| Nafion 112 | 50 | 25.1 |

The results clearly show that the membranes that have voids within the structure have significantly increased water uptake.

1. A proton conducting membrane characterised in that said membrane contains a network of voids within the thickness of the membrane.

2. A membrane as claimed in claim 1 wherein said membrane is 100 microns thick or less.

3. A membrane as claimed in any one of the preceding claims wherein the voids have a dimension of less than 20 microns in the z direction of the membrane.

4. A method for the generation of a membrane as claimed in any one of the preceding claims comprising the step of placing fibres within the membrane during its fabrication and subsequently substantially removing them to create a network of voids.

5. A method for the generation of a membrane as claimed in any one of claims 1 to 3 comprising the step of placing particles within the membrane during its fabrication and subsequently substantially removing them to create a network of voids.

6. A method for the generation of a membrane as claimed in any one of claims 1 to 3 comprising the step of placing fibres and particles within the membrane during its fabrication and subsequently substantially removing them to create a network of voids.

7. A method as claimed in any one or more of claims 4 to 6 wherein the fibres and/or particles are comprised of any one or more of the following: polyvinyl alcohol (PVA), polyimide, cellulose acetate, polyethylene oxide, cellulose nitrate, poly-saccharides and polyethylene glycols.

8. A method as claimed in claim 5 or claim 6 wherein the particles are comprised of at least one or more of the following: sodium dichloride, ammonium chloride, calcium carbonate or sucrose.

9. A method as claimed in any one or more of claims 4 to 8 wherein the fibres and/or particles are substantially removed by dissolution.

10. A method as claimed in any one or more of claims 4 to 8 wherein the fibres and/or particles are substantially removed by chemical decomposition.

11. A membrane electrode assembly (MEA) comprising a membrane as claimed in any one of claims 1 to 3.

12. A membrane electrode assembly (MEA) as claimed in claim 11 wherein said MEA shows improved performance at low reactant gas pressures close to ambient pressure.

13. A fuel cell comprising a membrane as claimed in any one of claims 1 to 3 or an MEA as claimed in claim 11 or claim 12.

14. A method of operating a fuel cell under cell reversal conditions, comprising the use of a membrane as claimed in any one of claims 1 to 3 to provide a reservoir of water within the membrane electrode assembly.

15. The use of a membrane according to the any one of claims 1 to 3 in a fuel cell wherein additional water is retained in the voids.
